(19) United States
(12) Patent Application Publication
(10) Pub. No.: US 2013/0217271 A1
(43) Pub. Date: Aug. 22, 2013

(54) ELECTRICAL CONNECTOR

(71) Applicants: Yi-Hsun Lin, Taipei City (TW); Yen-Chih Chen, Taipei City (TW); Wei-Chih Shih, Taipei City (TW); Tzu-Chiang Mi, Taipei City (TW); Ya-Lun Hsieh, Taipei City (TW); Hung-Tien Chang, Taipei City (TW); Feng-Ju Lee, Taipei City (TW)

(72) Inventors: Yi-Hsun Lin, Taipei City (TW); Yen-Chih Chen, Taipei City (TW); Wei-Chih Shih, Taipei City (TW); Tzu-Chiang Mi, Taipei City (TW); Ya-Lun Hsieh, Taipei City (TW); Hung-Tien Chang, Taipei City (TW); Feng-Ju Lee, Taipei City (TW)

(73) Assignee: COMPAL ELECTRONICS, INC., Taipei City (TW)

(21) Appl. No.: 13/762,359

(22) Filed: Feb. 7, 2013

Related U.S. Application Data
(60) Provisional application No. 61/599,935, filed on Feb. 17, 2012.

(51) Int. Cl. H01R 13/11

(52) U.S. Cl. CPC H01R 13/111
USPC 439/668

(57) ABSTRACT

An electrical connector includes a first terminal and a second terminal. The second terminal is fixed at the first terminal and enclosed by the first terminal, in which the second terminal includes a tube-shaped structure, the tube-shaped structure has a clipping portion and two end-surfaces, the two end-surfaces lean against each other to form a seam. The inner diameter of the clipping portion is smaller than the inner diameters of other portions of the tube-shaped structure. When a third terminal of a coupling connector is inserted into the tube-shaped structure to make the tube-shaped structure elastically deformed, the two end-surfaces are separated from each other and the clipping portion clips the third terminal.

### CROSS-REFERENCE TO RELATED APPLICATION

This application claims the priority benefits of U.S. provisional application Ser. No. 61/599,935, filed on Feb. 17, 2012. The entirety of the above-mentioned patent application is hereby incorporated by reference herein and made a part of this specification.

### BACKGROUND OF THE INVENTION

1. Field of the Invention

The invention generally relates to an electronic part, and more particularly, to an electrical connector.

2. Description of Related Art

Notebook computer has the same functions as the general desktop computer, and the volume and weight thereof are reduced by design to allow users easily carrying it, which makes the notebook computer become an indispensable portable tool for some users. With notebook's price continues to decline, some users even replace the desktop computer directly by the notebook computer.

As a portable electronic device, the notebook computer is usually equipped with an electrical connector electrically connected to other electronic devices for transmitting signals or supplying power. For example, in order to connect a notebook computer to the power supply, the notebook computer usually has a corresponding power connector so as to obtain the power by plugging it into a power supply. The conventional power connector mostly is a tuning-fork type electrical connector, where the terminals of the tuning-fork type electrical connector is able to clip the terminal of a coupling connector in two-point contact way. This clipping way, after multiple plugging and unplugging, easily leads the terminals to be worn and makes the clipping force insufficient. In addition, with the above-mentioned clipping in two-point contact way, the contact area between the terminals of the electrical connector and the terminal of the coupling connector is smaller, so that an overflow amount of current easily leads the terminal overheat to be burned, which restricts the upper limit of the rated current value.

### SUMMARY OF THE INVENTION

Accordingly, the invention is directed to an electrical connector having better clipping force on the terminal of the coupling connector and having a higher rated current value.

The invention provides an electrical connector, which includes a first terminal and a second terminal. The second terminal is fixed at the first terminal and enclosed by the first terminal, in which the second terminal includes a tube-shaped structure, the tube-shaped structure has a clipping portion and two end-surfaces, the two end-surfaces lean against each other to form a seam. The inner diameter of the clipping portion is smaller than the inner diameters of other portions of the tube-shaped structure. When a third terminal of a coupling connector is inserted into the tube-shaped structure to make the tube-shaped structure elastically deformed, the two end-surfaces are separated from each other and the clipping portion clips the third terminal.

In an embodiment of the invention, the third terminal is inserted into the tube-shaped structure along an inserting direction, and the extension direction of the seam is parallel to the inserting direction.

In an embodiment of the invention, the coupling connector has a fourth terminal, and when the third terminal is inserted into the tube-shaped structure, the fourth terminal contacts the first terminal.

In an embodiment of the invention, the first terminal and the fourth terminal are cathode, and the second terminal and the third terminal are anode.

In an embodiment of the invention, the inner diameter of the clipping portion is gradually reduced from a rear end of the clipping portion to a front end of the clipping portion.

In an embodiment of the invention, the inner diameters of at least a portion of the clipping portion are consistent.

In an embodiment of the invention, the tube-shaped structure has a plurality of openings and each of the openings goes through the clipping portion.

In an embodiment of the invention, the tube-shaped structure adjusts the contact area between the clipping portion and the third terminal by means of the quantity or area of the openings so as to control the clipping force of the clipping portion on the third terminal.

In an embodiment of the invention, the tube-shaped structure adjusts the contact area between the clipping portion and the third terminal by means of the quantity or area of the openings so as to control a rated current value between the electrical connector and the coupling connector.

In an embodiment of the invention, each of the openings is circular shape or square shape.

In an embodiment of the invention, the openings are formed at a metallic sheet and the metallic sheet is rolled into a tubular shape to form the tube-shaped structure.

In an embodiment of the invention, the clipping portion has a plurality of notches, each of the notches is sunken from exterior of the tube-shaped structure to interior of the tube-shaped structure, and the clipping portion clips the third terminal through the notches.

In an embodiment of the invention, the tube-shaped structure adjusts the contact area between the clipping portion and the third terminal by means of the quantity or area of the notches so as to control the clipping force of the clipping portion on the third terminal.

In an embodiment of the invention, the tube-shaped structure adjusts the contact area between the clipping portion and the third terminal by means of the quantity or area of the notches so as to control the rated current value between the electrical connector and the coupling connector.

In an embodiment of the invention, the second terminal has a fixing portion, and the second terminal is fixed at the first terminal through the fixing portion.

In an embodiment of the invention, the fixing portion is a spring sheet.

In an embodiment of the invention, the second terminal has a welding portion, the welding portion has a hole, and a conductive wire is connected to the hole by performing a hook-welding process.

In an embodiment of the invention, the clipping portion and the welding portion are respectively located at opposite two ends of the second terminal.

In an embodiment of the invention, the second terminal is integrally formed.

Based on the description above, the second terminal of the electrical connector in the invention includes a tube-shaped structure, which has a clipping portion used to clip a third terminal of the coupling connector. Since the third terminal of the coupling connector of the invention is clipped in the tube-shaped structure, not as the traditional way where the tuning-fork type electrical connector is clipped in the two-point contact manner, therefore, the second terminal of the electrical connector and the third terminal of the coupling connector have a larger contact area therebetween, which can increase the clipping force of the second terminal on the third terminal and advance the endurable amount of current of the second terminal and the third terminal, and thus, the electrical connector has a higher rated current value.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a three-dimensional diagram of an electrical connector according to an embodiment of the invention.

FIG. 2 is an exploded diagram of the electrical connector in FIG. 1.

FIG. 3 is a cross-sectional diagram along line I-I of the second terminal in FIG. 2.

FIG. 4 is a cross-sectional diagram showing a coupling connector inserted into the electrical connector of FIG. 1.

FIG. 5 is a schematic diagram showing separated two end-surfaces of FIG. 3.

FIGS. 6A-6E are partial three-dimensional diagrams of tube-shaped structures in other embodiments of the invention.

FIG. 7 is a partial three-dimensional diagram of a second terminal according to another embodiment of the invention.

FIG. 8 is a cross-sectional diagram if an electrical connector according to another embodiment of the invention.

### DESCRIPTION OF THE EMBODIMENTS

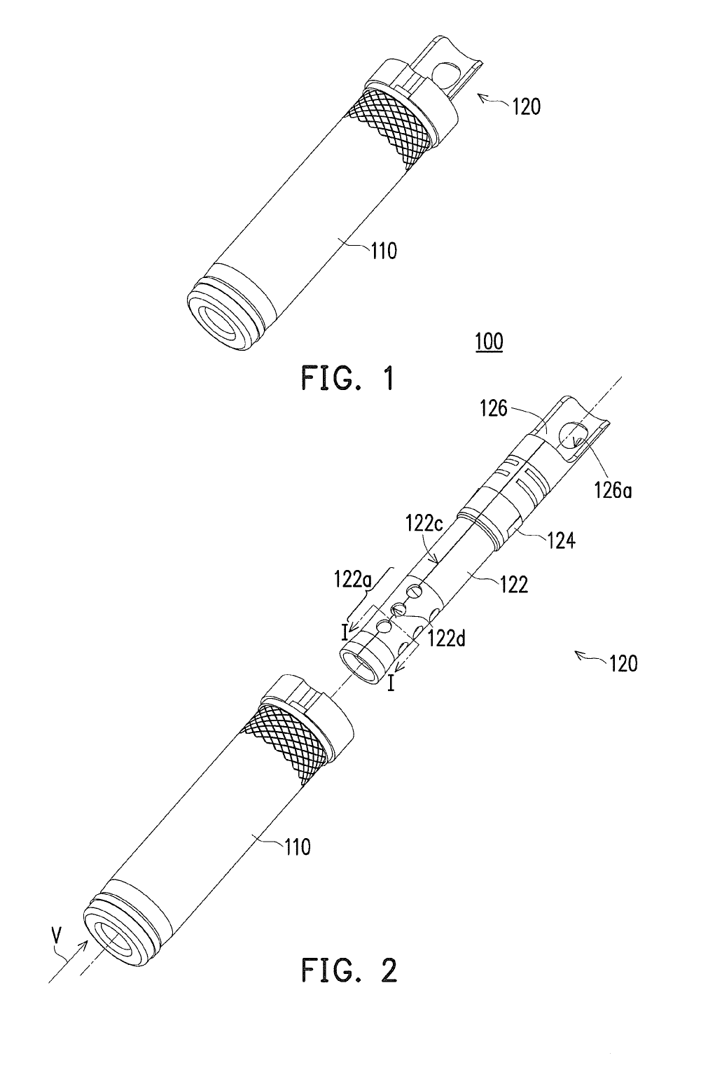

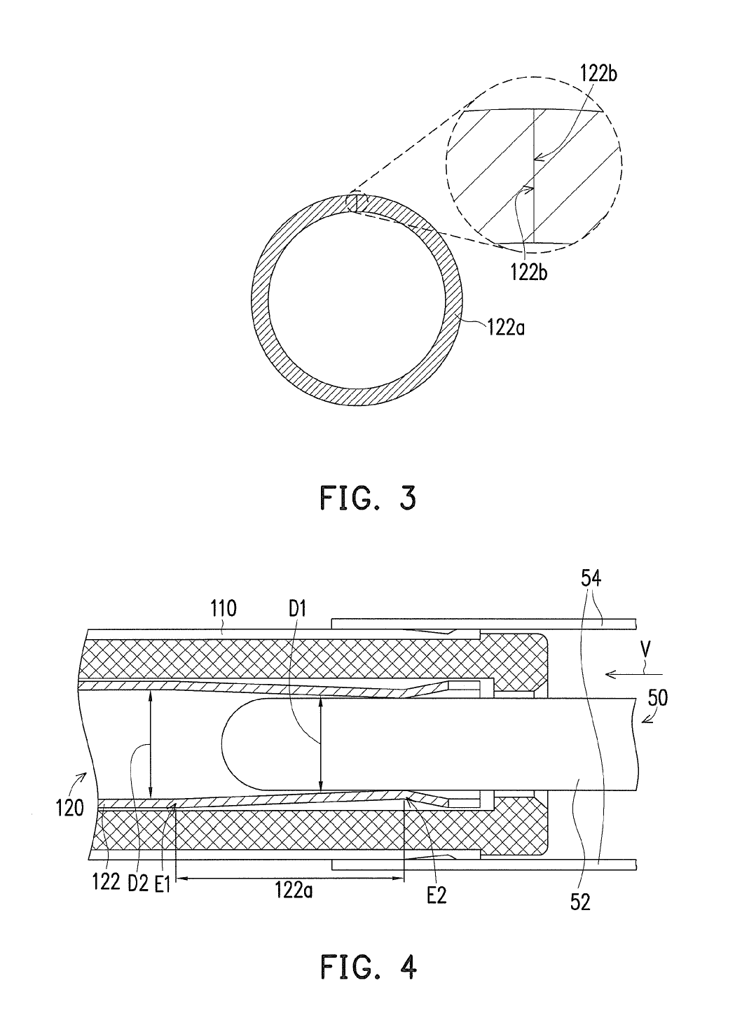

FIG. 1 is a three-dimensional diagram of an electrical connector according to an embodiment of the invention, FIG. 2 is an exploded diagram of the electrical connector in FIG. 1 and FIG. 3 is a cross-sectional diagram along line I-I of the second terminal in FIG. 2. Referring to FIGS. 1-3, an electrical connector 100 of the embodiment is, for example, a power connector of electronic device and includes a first terminal 110 and a second terminal 120. The first terminal 110 is, for example, the cathode of the electrical connector 100 and the second terminal 120 is, for example, the anode of the electrical connector 100. The second terminal 120 is fixed at the first terminal 110 and enclosed by the first terminal 110. The second terminal 120 includes a tube-shaped structure 122, the tube-shaped structure 122 has a clipping portion 122a and two end-surfaces 122b, and the two end-surfaces 122b lean against each other to form a seam 122c.

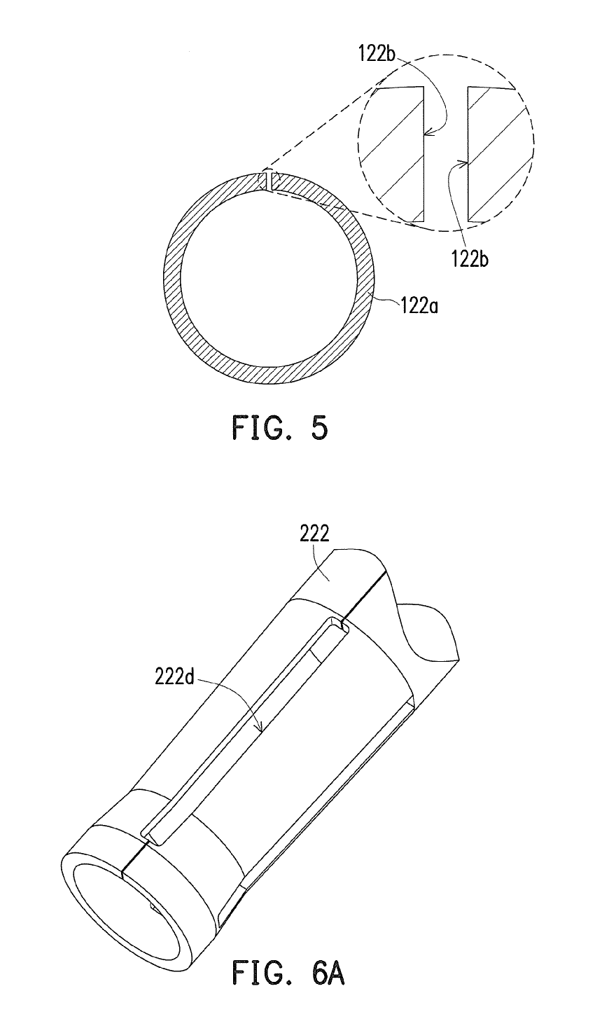

FIG. 4 is a cross-sectional diagram showing a coupling connector inserted into the electrical connector of FIG. 1 and FIG. 5 is a schematic diagram showing separated two end-surfaces of FIG. 3. Referring to FIG. 4, the inner diameter D1 of the clipping portion 122a is gradually reduced from a rear end E1 of the clipping portion 122a to a front end E2 of the clipping portion 122a, and thus, the inner diameter D1 of the clipping portion 122a is smaller than the inner diameters D2 of other portions of the tube-shaped structure 122. When a third terminal 52 of a coupling connector 50 is inserted into the tube-shaped structure 122 as shown by FIG. 4 to make the tube-shaped structure 122 elastically deformed, the two end-surfaces 122b of the tube-shaped structure 122 would be separated from each other as shown by FIG. 5 and the clipping portion 122a with the smaller inner diameter D1 clips the third terminal 52 through the elastic force of the tube-shaped structure 122.

Since the third terminal 52 of the coupling connector 50 is clipped in the tube-shaped structure 122, not as the traditional way where the tuning-fork type electrical connector is clipped in the two-point contact manner, therefore, the second terminal 120 of the electrical connector 100 and the third terminal 52 of the coupling connector 50 have a larger contact area therebetween, which can increase the clipping force of the second terminal 120 on the third terminal 52 and advance the endurable amount of current of the second terminal 120 and the third terminal 52, and thus, the electrical connector 100 has a higher rated current value.

In the embodiment, the third terminal 52 of the coupling connector 50 is inserted into the tube-shaped structure 122 along an inserting direction V as shown by FIGS. 1, 2 and 4. The extension direction of the seam 122c of the tube-shaped structure 122 is, for example, parallel to the inserting direction V. In other embodiments, the seam 122c can have other appropriate extension directions, which the invention is not limited to.

As shown by FIG. 4, the coupling connector 50 further has a fourth terminal 54, in which the third terminal 52 is, for example, the anode of the electrical connector 100, while the fourth terminal 54 is, for example, the cathode of the electrical connector 100. When the coupling connector 50 is plugged into the electrical connector 100 to make the third terminal 52 inserted into the tube-shaped structure 122, the fourth terminal 54 of the coupling connector 50 contacts the first terminal 110 of the electrical connector 100 to fulfil the electrical connection between the coupling connector 50 and the electrical connector 100.

Referring to FIG. 2, in the embodiment, the tube-shaped structure 122 of the second terminal 120 has a plurality of openings 122d, and each of the openings 122d goes through the clipping portion 122a. More the quantity of the openings 122d, the smaller the contact area between the clipping portion 122a and the third terminal 52 of the coupling connector 50 (shown by FIG. 4) is. As a result, the clipping force of the clipping portion 122a on the third terminal 52 is reduced, and the endurable amount of current of the second terminal 120 and the third terminal 52 is reduced as well. On contrary, the less the quantity of the openings 122d, the larger the contact area between the clipping portion 122a and the third terminal 52 of the coupling connector 50 is. As a result, the clipping force of the clipping portion 122a on the third terminal 52 is increased, and the endurable amount of current of the second terminal 120 and the third terminal 52 is increased as well. In addition, the larger the area of each of the openings 122d, the smaller the contact area between the clipping portion 122a and the third terminal 52 of the coupling connector 50 is, which reduces the clipping force of the clipping portion 122a on the third terminal 52 and reduces the endurable amount of current of the second terminal 120 and the third terminal 52. On contrary, the smaller the area of each of the openings 122d, the larger the contact area between the clipping portion 122a and the third terminal 52 of the coupling connector 50 is, which increases the clipping force of the clipping portion 122a on the third terminal 52 and increases the endurable amount of current of the second terminal 120 and the third terminal 52.

Based on the above-mentioned feature, the tube-shaped structure 122 can adjust the contact area between the clipping portion 122a and the third terminal 52 of the coupling connector 50 by means of the quantity and area of the openings 122d so as to control the clipping force of the clipping portion 122a on the third terminal 52 depending on the requirement. As a result, the user can plug/unplug the coupling connector 50 into/from the electrical connector 100 with an appropriate swapping operation force. Moreover, the tube-shaped structure 122 can adjust the contact area between the clipping portion 122a and the third terminal 52 of the coupling connector 50 by means of the quantity and area of the openings 122d so as to control the rated current value between the electrical connector 100 and the coupling connector 50 depending on the requirement.

In the embodiment, the second terminal 120, is, for example, an integrally formed structure. The fabrication method of the tube-shaped structure 122 includes, for example, the following steps: forming a plurality of openings at a metallic sheet; rolling the metallic sheet into tubular shape to form the tube-shaped structure 122, in which the openings formed at the metallic sheet are the openings 122d of the tube-shaped structure 122

Referring to FIG. 2, in the embodiment, the second terminal 120 has at least one fixing portion 124 and the fixing portion 124 is, for example, a spring sheet. The second terminal 120 is fixed at the first terminal 110 through the fixing portion 124. In other embodiments, the second terminal 120 can be fixed at the first terminal 110 through other appropriate structures, which the invention is not limited to. The second terminal 120 further has a welding portion 126, and the clipping portion 122a and the welding portion 126 are respectively located at the opposite two ends of the second terminal 120. The welding portion 126 has a hole 126a, and a conductive wire (not shown) is connected to the hole 126a by performing a hook-welding process so that the second terminal 120 is electrically connected to the parts inside the electronic device via the conductive wire.

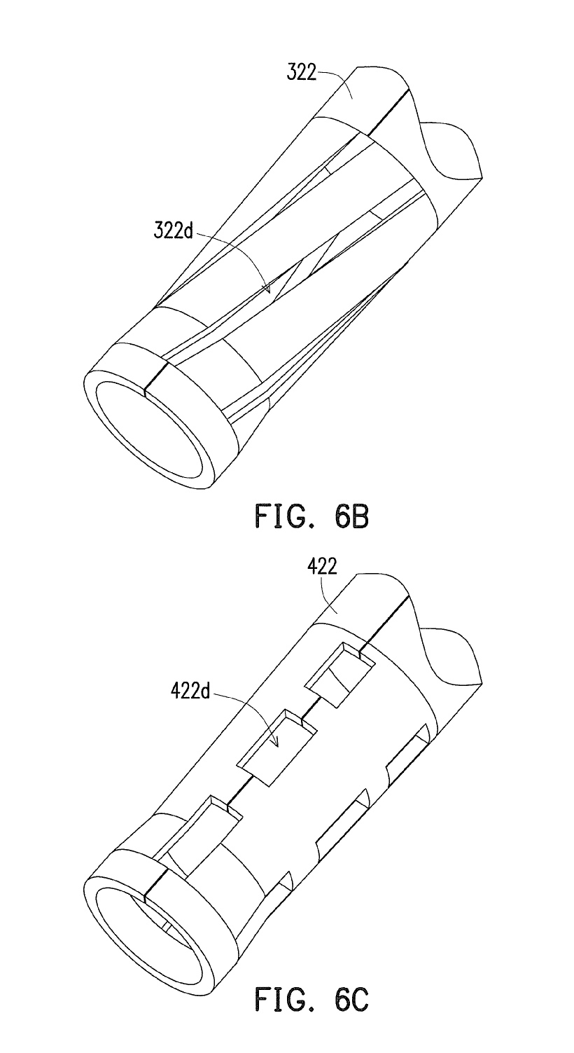

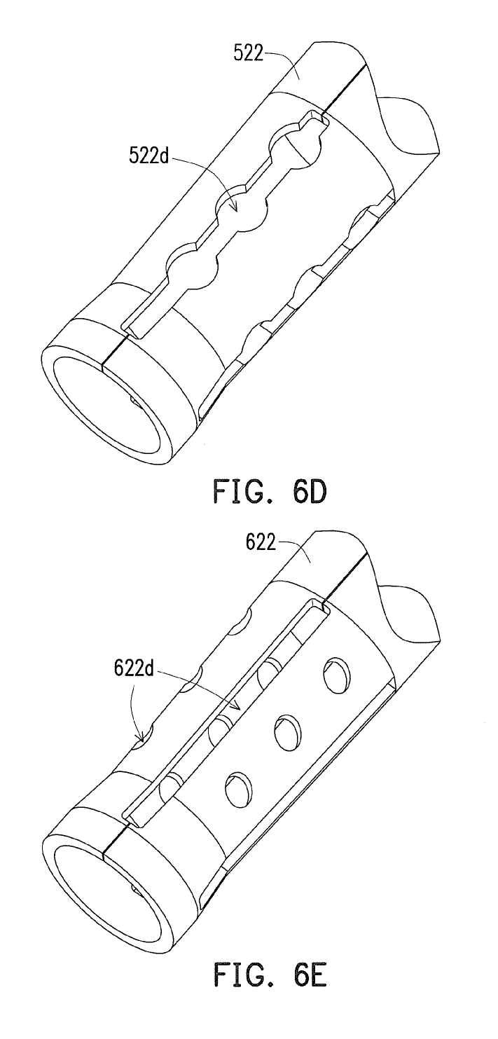

Referring to FIG. 2, in the embodiment, each of the openings 122d of the tube-shaped structure 122 is, for example, circular shape. The invention does not limit the shape of the openings 122d, which is described by some examples in association with figures. FIGS. 6A-6E are partial three-dimensional diagrams of tube-shaped structures in other embodiments of the invention. In other embodiments, the openings 222d of the tube-shaped structure 222 are long-groove-like by design as shown by FIG. 6A, or the openings 322d of the tube-shaped structure 322 are long-groove-like and arranged in a helical way by design as shown by FIG. 6B, or the openings 422d of the tube-shaped structure 422 are square shape by design as shown by FIG. 6C, or the openings 522d of the tube-shaped structure 522 are long-groove-like with circle holes by design as shown by FIG. 6D, or the openings 622d of the tube-shaped structure 622 are both long-groove-like and circular shape respectively by design as shown by FIG. 6E.

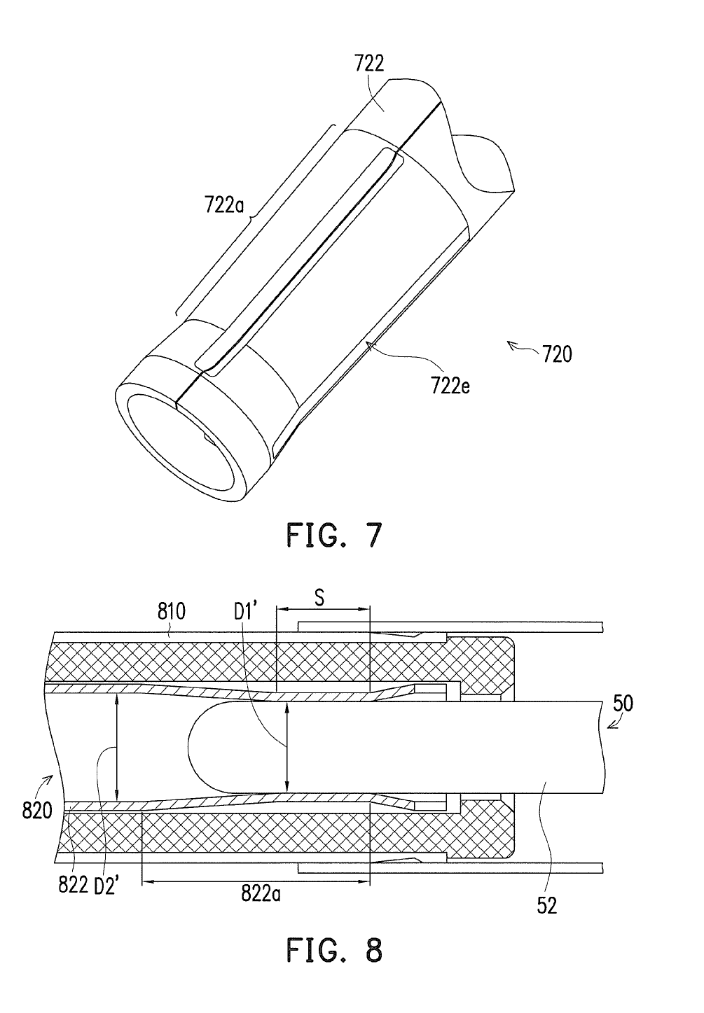

FIG. 7 is a partial three-dimensional diagram of a second terminal according to another embodiment of the invention. Referring to FIG. 7, in the second terminal 720 of the embodiment, the clipping portion 722a of the tube-shaped structure 722 is similar to the clipping portion 122a of the tube-shaped structure 122 in FIGS. 2-4, both have smaller inner diameter to facilitate clipping the third terminal 52 of the coupling connector 50 (as shown by FIG. 4). The difference of the clipping portion 722a from the clipping portion 122a rests in that the clipping portion 722a has a plurality of notches 722e, each of the notches 722e does not go through the tube-shaped structure 722 and is sunken from the exterior of the tube-shaped structure 722 to the interior of the tube-shaped structure 722. The clipping portion 722a of the embodiment is suitable to clip the third terminal 52 of the coupling connector 50 through the notches 722e.

The more the quantity of the notches 722e, the larger the contact area between the clipping portion 722a and the third terminal 52 of the coupling connector 50 (shown by FIG. 4) is. As a result, the clipping force of the clipping portion 722a on the third terminal 52 is increased, and the endurable amount of current of the second terminal 720 and the third terminal 52 is increased as well. On contrary, the less the quantity of the notches 722e, the smaller the contact area between the clipping portion 722a and the third terminal 52 of the coupling connector 50 is. As a result, the clipping force of the clipping portion 722a on the third terminal 52 is reduced, and the endurable amount of current of the second terminal 720 and the third terminal 52 is reduced as well. In addition, the larger the area of each of the notches 722e, the larger the contact area between the clipping portion 722a and the third terminal 52 of the coupling connector 50 is, which increases the clipping force of the clipping portion 722a on the third terminal 52 and increases the endurable amount of current of the second terminal 720 and the third terminal 52. On contrary, the smaller the area of each of the notches 722e, the smaller the contact area between the clipping portion 722a and the third terminal 52 of the coupling connector 50 is, which reduces the clipping force of the clipping portion 722a on the third terminal 52 and reduces the endurable amount of current of the second terminal 720 and the third terminal 52.

Based on the above-mentioned feature, the tube-shaped structure 722 can adjust the contact area between the clipping portion 722a and the third terminal 52 of the coupling connector 50 by means of the quantity and area of the notches 722e so as to control the clipping force of the clipping portion 722a on the third terminal 52 depending on the requirement. As a result, the user can plug/unplug the coupling connector 50 into/from the electrical connector with an appropriate swapping operation force. Moreover, the tube-shaped structure 722 can adjust the contact area between the clipping portion 722a and the third terminal 52 of the coupling connector 50 by means of the quantity and area of the notches 722e so as to control the endurable amount of current between the electrical connector and the coupling connector 50 depending on the requirement. In addition, the openings similar to the ones in FIG. 2 or FIGS. 6A-6E can be further formed on the tube-shaped structure 722 so as to control the clipping force of the clipping portion 722a on the third terminal 52 and the rated current value between the electrical connector and the coupling connector 50.

FIG. 8 is a cross-sectional diagram if an electrical connector according to another embodiment of the invention. The layout of the first terminal 810 is similar to the second terminal 820, and the clipping portion 822a of the tube-shaped structure 822 is similar to the clipping portion 122a of the tube-shaped structure 122 in FIGS. 2-4, both have smaller inner diameter to facilitate clipping the third terminal 52 of the coupling connector 50. The difference of the second terminal 820 from the second terminal 120 rests in that the inner diameters D1′ of a part of the clipping portion 822a are consistent (as shown by FIG. 8, section S) and the inner diameter D1′ of the section S is smaller than the inner diameters D2′ of the rest part of the second terminal 820 so that the clipping portion 822a is suitable to use the section S for clipping the third terminal 52. Thus, the contact area between the third terminal 52 and the clipping portion 822a can be changed by adjusting the length of the section S of the clipping portion 822a so as to control the clipping force of the clipping portion 822a on the third terminal 52 and the rated current value between the electrical connector and the coupling connector 50.

In summary, the second terminal of the electrical connector in the invention includes a tube-shaped structure, which has a clipping portion used to clip a third terminal of the coupling connector. Since the third terminal of the coupling connector of the invention is clipped in the tube-shaped structure, not as the traditional way where the tuning-fork type electrical connector is clipped in the two-point contact manner, therefore, the second terminal of the electrical connector and the third terminal of the coupling connector have a larger contact area therebetween, which can increase the clipping force of the second terminal on the third terminal and advance the endurable amount of current of the second terminal and the third terminal, and thus, the electrical connector has a higher rated current value. In addition, by forming the openings or notches at the tube-shaped structure of the second terminal, the contact area between the second terminal and the third terminal can be adjusted through changing the quantity and area of the openings or the notches, and the clipping force of the clipping portion of the second terminal on the third terminal and the rated current value between the electrical connector and the coupling connector can be controlled depending on the requirement.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electrical connector, comprising:
a first terminal; and
a second terminal, fixed at the first terminal and enclosed by the first terminal, wherein the second terminal comprises a tube-shaped structure, the tube-shaped structure has a clipping portion and two end-surfaces, the two end-surfaces lean against each other to form a seam, and an inner diameter of the clipping portion is smaller than inner diameters of other portions of the tube-shaped structure,
wherein when a third terminal of a coupling connector is inserted into the tube-shaped structure to make the tube-shaped structure elastically deformed, the two end-surfaces are separated from each other and the clipping portion clips the third terminal.

2. The electrical connector as claimed in claim 1, wherein the third terminal is inserted into the tube-shaped structure along an inserting direction, and an extension direction of the seam is parallel to the inserting direction.

3. The electrical connector as claimed in claim 1, wherein the coupling connector has a fourth terminal, and when the third terminal is inserted into the tube-shaped structure, the fourth terminal contacts the first terminal.

4. The electrical connector as claimed in claim 3, wherein the first terminal and the fourth terminal are cathode, and the second terminal and the third terminal are anode.

5. The electrical connector as claimed in claim 1, wherein the inner diameter of the clipping portion is gradually reduced from a rear end of the clipping portion to a front end of the clipping portion.

6. The electrical connector as claimed in claim 1, wherein inner diameters of at least a portion of the clipping portion are consistent.

7. The electrical connector as claimed in claim 1, wherein the tube-shaped structure has a plurality of openings and each of the openings goes through the clipping portion.

8. The electrical connector as claimed in claim 7, wherein the tube-shaped structure adjusts the contact area between the clipping portion and the third terminal by means of the quantity or area of the openings so as to control a clipping force of the clipping portion on the third terminal.

9. The electrical connector as claimed in claim 7, wherein the tube-shaped structure adjusts the contact area between the clipping portion and the third terminal by means of the quantity or area of the openings so as to control a rated current value between the electrical connector and the coupling connector.

10. The electrical connector as claimed in claim 7, wherein each of the openings is circular shape or square shape.

11. The electrical connector as claimed in claim 7, wherein the openings are formed at a metallic sheet and the metallic sheet is rolled into a tubular shape to form the tube-shaped structure.

12. The electrical connector as claimed in claim 1, wherein the clipping portion has a plurality of notches, each of the notches is sunken from exterior of the tube-shaped structure to interior of the tube-shaped structure, and the clipping portion clips the third terminal through the notches.

13. The electrical connector as claimed in claim 12, wherein the tube-shaped structure adjusts the contact area between the clipping portion and the third terminal by means of the quantity or area of the notches so as to control the clipping force of the clipping portion on the third terminal.

14. The electrical connector as claimed in claim 12, wherein the tube-shaped structure adjusts contact area between the clipping portion and the third terminal by means of the quantity or area of the notches so as to control the rated current value between the electrical connector and the coupling connector.

15. The electrical connector as claimed in claim 1, wherein the second terminal has a fixing portion, and the second terminal is fixed at the first terminal through the fixing portion.

16. The electrical connector as claimed in claim 15, wherein the fixing portion is a spring sheet.

17. The electrical connector as claimed in claim 1, wherein the second terminal has a welding portion, the welding portion has a hole, and a conductive wire is connected to the hole by performing a hook-welding process.

18. The electrical connector as claimed in claim 17, wherein the clipping portion and the welding portion are respectively located at opposite two ends of the second terminal.

19. The electrical connector as claimed in claim 1, wherein the second terminal is integrally formed.
